(19) United States
(12) Patent Application Publication
(10) Pub. No.: US 2010/0031517 A1
(43) Pub. Date: Feb. 11, 2010

(54) Handheld reciprocating saw and the operating method thereof

(76) Inventors: Masatoshi Fukinuki, Nanjing (CN); Guigong Ni, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/462,508

(22) Filed: Aug. 5, 2009

(30) Foreign Application Priority Data
Aug. 6, 2008 (CN) 200810021587.9

(51) Int. Cl. B23D 49/10; B23D 49/16

(52) U.S. Cl. 30/374; 30/392

(57) ABSTRACT

A handheld reciprocating saw includes a housing, a motor, a sole plate attached to the housing and having a bottom surface. The housing comprises a first housing portion which has a first longitudinal central axis and a second housing portion which has a second longitudinal central axis. An angle is formed between the first longitudinal central axis and the second longitudinal central axis. A battery is attached to one of the first housing portion and the second housing portion, and the motor is mounted in the other one of the first housing portion and the second housing portion. The first housing portion is formed with Ma first gripping portion extending in a direction of the first longitudinal central axis, and the second housing portion is formed with a second gripping portion extending in a direction of the second longitudinal central axis. The handheld reciprocating saw thereby provides at least two gripping options in at least two different directions, enhancing the versatility and usefulness of the saw.

This application claims priority under 35 U.S.C. 119 to CN 200810021587.9 filed Aug. 6, 2008, and is hereby incorporated by reference.

### BACKGROUND OF THE INVENTION

The present invention relates to a handheld reciprocating saw, and particularly to a handheld reciprocating saw with the ability to be operated with one hand, which can be used for a variety of construction and building projects.

Reciprocating saw, such as a jig saw, a saber saw, etc, is a portable cutting tool which can be used for cutting by reciprocating movement of a saw blade.

A handheld reciprocating saw generally comprises a sole plate attached to a body, a saw blade connected to a drive system and extending out of a bottom surface of the sole plate, a main gripping portion formed on or mounted on the body, and a power switch of the drive system. The existing reciprocating saw is generally provided with the main gripping portion in one direction for being gripped by an operator. U.S. patent application Ser. No. 11/004,334 discloses a jig saw whose main gripping portion comprises two portions, one is a gripping portion on a motor housing, and the other one is a gripping portion on a detachable handle. The both gripping directions of these two gripping portions are identical and substantially parallel to the bottom surface of the sole plate. U.S. Pat. No. 5,007,172 discloses a saber saw whose handle (i.e. main gripping portion) is located at a rear side of the body, and the gripping direction of the handle is substantially parallel to the bottom surface of the sole plate. When operating these saws, especially in cutting vertical surfaces, the main gripping direction of the operator is substantially parallel to a gravity direction of the saws. Vibration generated during cutting requires the operator to grip the saw more firmly to prevent the saw from sliding or moving and to ensure the precision of the cutting. Sometimes the operator may be required to hold the body of the saw with both hands, which means that the operator cannot perform other functions, such as holding the piece to be cut. In this manner, the effectiveness, accuracy and comfort of operating the saw may be reduced. The present invention overcomes the disadvantages in the prior art and provides a handheld reciprocating saw which is structurally compact, convenient to use, and can be used for a variety of cutting operations.

### SUMMARY OF THE INVENTION

The handheld reciprocating saw comprises a housing comprising a first housing portion having a first longitudinal central axis and a second housing portion which has a second longitudinal central axis, with an angle being formed between the first longitudinal central axis and the second longitudinal central axis, a motor disposed within the housing, a sole plate attached to the housing and having a bottom surface, a saw blade attached to the motor via a transmission device and passing through the sole plate, and a battery connected to the motor, which is connected to one of the first housing portion and the second housing portion. The motor is mounted within one of the first housing portion and the second housing portion. The first housing portion has a first gripping section having a gripping direction substantially along a direction of the first longitudinal central axis, while the second housing portion has a second gripping section having a gripping direction substantially along a direction of the second longitudinal central axis.

Because the handheld reciprocating saw according to the present invention provides the two gripping sections in two different directions, the operator can choose different gripping options according to the operating and cutting requirements, providing the operator with several options for the same saw. The handheld reciprocating saw according to the present invention also provides a portable power supply, for example, a battery. The battery and the motor may be connected to the first and second housing portion in two different directions, respectively. Therefore, without the requirement of a separate power source, the handheld reciprocating saw is portable and structurally more compact for convenient carrying and storage.

The structure of the saw of the present invention provides an advantage in that it does not require the operator to grip the saw with both hands when in use. The operator can grip one of the first and the second housing portions along a direction corresponding to one of the first and the second longitudinal central axes with one hand, operate the switch button to turn on the power with the other hand, and grip one of the first and the second housing portions with one hand to perform the cutting. In this manner, the operator can use one hand to do other supplementary functions, such as holding the workpiece to be cut and so on, while operating the saw. It is particularly useful to grip the reciprocating saw with one hand when cutting in narrow space.

### BRIEF DESCRIPTION OF THE DRAWINGS

FIG. 1 is a sectional view of a handheld reciprocating saw according to the present invention.

FIG. 2 is a schematic view of the handheld reciprocating saw in FIG. 1 when cutting in a vertical plane.

FIG. 3 is a schematic view of the handheld reciprocating saw in FIG. 1 when cutting in a horizontal plane.

### DETAILED DESCRIPTION OF THE PREFERRED EMBODIMENTS

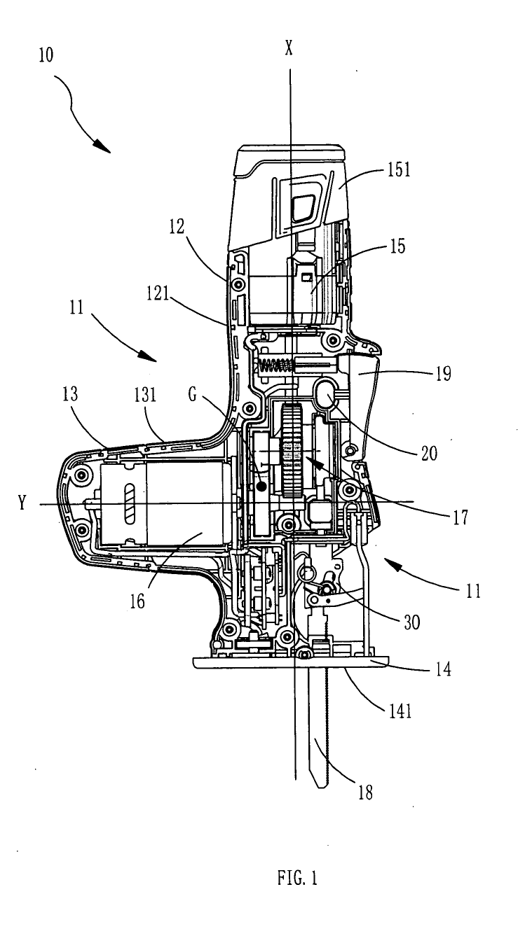

As shown in FIG. 1, a handheld reciprocating saw 10 of a preferred embodiment according to the present invention comprises a housing 11. The housing 11 comprises a first housing portion 12, which extends along the first longitudinal central axis X, and a second housing portion 13, which extends along the second longitudinal central axis Y. In a preferred embodiment, the first longitudinal central axis X is substantially perpendicular to the second longitudinal central axis Y, forming an angle of approximately 90 degrees. A sole plate 14 is mounted to the housing 11 and has a bottom surface 141, which is substantially parallel to the second longitudinal central axis Y, while a direction of the first longitudinal central axis X passes through the bottom surface 141. A motor 16 is mounted within the second housing portion 13. A battery 15 is attached to the first housing portion 12 through groove-protrusion structures between the battery housing 151 and the top end of the first housing portion 12. At least a portion of the battery is preferably inserted into the first housing portion 12 making the connection between the battery and the first housing portion 12 more secure. The outer surface of the battery housing 151 abuts the first housing portion 12 smoothly so that the connection between the battery housing 151 and the first housing portion 12 does not break the overall profile of the reciprocating saw.

A switch button 19 mounted on the first housing portion 12 controls a switch (not shown in the drawings) which is connected to the battery 15 and the motor 16. A locking button 20 is further mounted to the first housing portion 11 for selectively locking the switch button 19 in a down or “on” state. When the switch button 19 is pressed down, the switch turns on the power, wherein the battery 15 supplies the power to the motor 16. The switch button 19 is locked by pressing the locking button 20 down to keep the switch in a closed state.

A transmission mechanism 17 is mounted within the housing 11, and its input portion is connected to the motor 16. In this embodiment, the transmission mechanism is disposed at the position where the first housing portion 12 associates with the second housing portion 13. An elongated saw blade 18 is connected to an output shaft of the transmission mechanism 17 by a clamping means 30 and passes through the sole plate 14. The transmission mechanism 17 is adapt to convert rotational movements of the motor into reciprocating movements of the saw blade so as to implement cutting operations. Transmission mechanisms are well-known in the art.

As shown in the drawings, the first housing portion 12 includes a first gripping section 121 having a gripping direction extending along the first longitudinal central axis X, which is suitable to be gripped by one hand. The gripping direction along the first longitudinal central axis X indicates that the operator's fingers bend around the direction of the first longitudinal central axis X while gripping. Similarly, the second housing portion 13 includes a second gripping section 131 having a gripping direction extending along the second longitudinal central axis Y and which is suitable to be gripped by one hand. In this manner, the reciprocating saw provides the operator with at least two gripping options in at least two different directions to perform cutting operations in various positions.

Those skilled in the art will understand that the angle between the first longitudinal central axis X and the second longitudinal central axis Y while preferably 90 degrees, can also be between about 80˜100 degrees while permitting the saw to function in the same manner. Optionally, the sole plate can further be arranged to be rotatable with respect to the housing and the second longitudinal central axis Y is substantially parallel to the bottom surface of the sole plate at a position where the sole plate does not rotate.

In order to understand the present invention better, cutting in a vertical plane and cutting in a horizontal plane, which are the most commonly used positions of the reciprocating saw, will be discussed below to help to further understand the features of the handheld reciprocating saw according to the present invention.

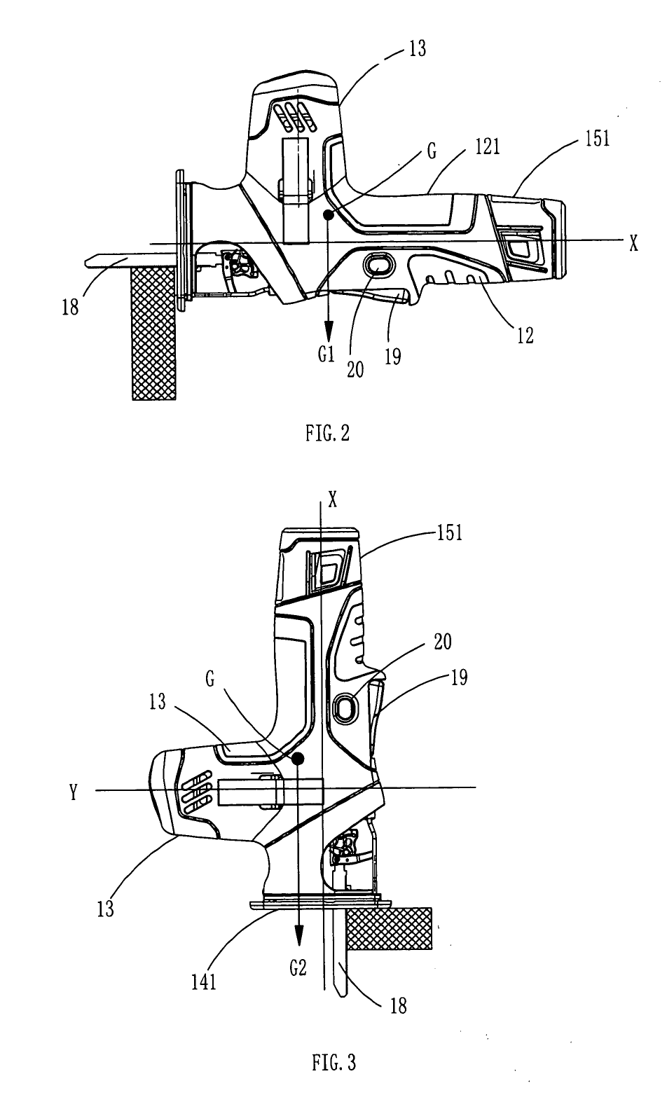

FIG. 2 is a schematic view of the handheld reciprocating saw according to the present invention in FIG. 1 while cutting in the vertical plane. When the operator is cutting, one hand grips the first gripping section 121 of the first housing portion 12 along the first central axis X, operates the switch button 19 to connect the power supply to the motor, then presses down the locking button 20 to lock the switch button 19 at a position where the switch is kept in a closed state, so that the vertical plane can be cut thereby. In this position, a gravity line G1 of the reciprocating saw 10 is perpendicular to the gripping direction (that is, the direction of the first central axis X), such that when the operator operates the saw with one hand, the reciprocating saw will not easily slip out of the operator's hand, permitting the operator to cut steadily with one hand. The ability to operate the saw with one hand is particularly useful for cutting in a narrow space or when it is necessary to hold the workpiece while cutting. In addition, when cutting in other positions, for example, such as an inclined angle, the center of gravity of the reciprocating saw and the gripping direction of the first gripping portion have an angle formed therebetween, which also makes the reciprocating saw more stable and easier to handle.

FIG. 3 is a schematic view of the handheld reciprocating saw according to the present invention in FIG. 1 when cutting in a horizontal plane. When the operator is cutting, the operator grips the second gripping section 131 of the second housing portion 13 with one hand along the second central axis Y, and operates the switch button 19 with the other hand to connect the power supply to the motor. The operator then presses down the locking button 20 to keep the switch button 19 at a position where the switch is kept in a closed state, while gripping the second gripping section 131 with one hand to push the reciprocating saw 10 to cut in the desired direction. During cutting, the sole plate 14 is disposed on the surface of the workpiece as a support to the reciprocating saw 10 to prevent it from swaying at random resulting from the vibration caused by the cutting.

In order to ensure the stability of the support to the sole plate 14 of the reciprocating saw 10, the center of gravity G is exactly located above the bottom surface 141 of the sole plate and its gravity line G2 passes through the bottom surface 141 of the sole plate 14 at least when the bottom surface 141 of the sole plate is in a horizontal position. Furthermore, in order to improve the stability of the reciprocating saw 10 when precise cutting is performed in the horizontal direction, the position of the center of gravity G should be as low as possible. Hence, the second housing portion 13 is disposed near the sole plate 14, wherein the distance between the second housing portion 13 and the bottom surface 141 of the sole plate is less than half of a distance between the top end of the battery 15 on the first housing portion 12 and the bottom surface 141 of the sole plate, and is preferably one third of the distance between the top end of the battery 15 on the first housing portion 12 and the bottom surface 141 of the sole plate.

Additionally, in order to ensure that the center of gravity G of the reciprocating saw can be exactly located above and as close to the center of the bottom surface 141 of the sole plate (i.e. the gravity line G2 can exactly pass through the bottom surface 141) when in the horizontal position, the motor 16 and the battery 15 of the reciprocating saw 10 are mounted on the second housing portion 13 and the first housing portion 12, respectively.

Those skilled in the art will understand that the switch button can also be disposed at various positions on the housing in other embodiments, and that the motor can also be mounted in the first housing portion while the battery can be mounted in the second housing portion in other embodiments.

The above described preferred embodiments are intended to illuminate the principle of the present invention, but not to restrict the scope of the present invention. It can be easily understood for those skilled in the art that many other modifications and variations of the preferred embodiments will be apparent and may be made without departing from the spirit and the scope of the present invention.

We claim:

1. A handheld reciprocating saw comprising:
a housing having a first housing portion having a first longitudinal central axis and a second housing portion having a second longitudinal central axis, with an angle formed between the first longitudinal central axis and the second longitudinal central axis;
a motor disposed within the housing;
a sole plate attached to the housing and having a bottom surface;
a saw blade attached to the motor via a transmission device and passing through the sole plate; and
a battery connected to the motor.

2. The handheld reciprocating saw according to claim 1, wherein the motor is mounted within one of the first housing portion and the second housing portion.

3. The handheld reciprocating saw according to claim 1, wherein the first housing portion is formed with a first gripping section having a gripping direction substantially along a direction of the first longitudinal central axis.

4. The handheld reciprocating saw according to claim 1, wherein the second housing portion is formed with a second gripping section having a gripping direction substantially along a direction of the second longitudinal central axis.

5. The handheld reciprocating saw according to claim 1, wherein the angle is between about 80˜100 degrees.

6. The handheld reciprocating saw according to claim 1, wherein the first longitudinal central axis is substantially perpendicular to the second longitudinal central axis.

7. The handheld reciprocating saw according to claim 1, wherein the battery is at least partially disposed in the one of the first housing portion and the second housing portion.

8. The handheld reciprocating saw according to claim 7, wherein the battery comprises a battery housing having an external surface abutting an external surface of the one of the first housing portion and the second housing portion.

9. The handheld reciprocating saw according to claim 1, wherein when the reciprocating saw is disposed on a support surface with the bottom surface of the sole plate being substantially horizontal, wherein the reciprocating saw has a center of gravity above and passing through the sole plate.

10. A handheld reciprocating saw comprising:
a housing having a first housing portion having a first longitudinal central axis and a second housing portion having a second longitudinal central axis, wherein an angle is formed between the first longitudinal central axis and the second longitudinal central axis;
a motor disposed within the housing;
a sole plate attached to the housing and having a bottom surface;
a saw blade attached to the motor via a transmission device and passing through the sole plate; and,
wherein the first housing portion is formed with a first gripping portion having a gripping direction substantially along a direction of the first longitudinal central axis, and wherein the second housing portion is formed with a second gripping portion having a gripping direction substantially along a direction of the second longitudinal central axis.

11. The handheld reciprocating saw according to claim 10, wherein the motor is disposed in the second housing portion, the battery is connected to the first housing portion, the second longitudinal central axis is substantially parallel to the bottom surface of the sole plate, and a distance between the second longitudinal central axis and the bottom surface of the sole plate is less than half of a distance between a top end of the battery on the first housing portion and the bottom surface of the sole plate.

12. The handheld reciprocating saw according to claim 11, wherein a ratio of the distance from the second longitudinal central axis to the bottom surface of the sole plate to the distance from the top end of the battery on the first housing portion to the bottom surface of the sole plate is 1:3.
